(19) United States
(12) Patent Application Publication
(10) Pub. No.: US 2021/0042228 A1
(43) Pub. Date: Feb. 11, 2021

(54) CONTROLLER FOR LOCKING OF SELECTED CACHE REGIONS

(71) Applicant: Intel Corporation, Santa Clara, CA (US)

(72) Inventors: Andrew J. HERDRICH, Hillsboro, OR (US); Priya AUTEE, Chandler, AZ (US); Abhishek KHADE, Chandler, AZ (US); Patrick LU, Chandler, AZ (US); Edwin VERPLANKE, Chandler, AZ (US); Vedvyas SHANBHOGUE, Austin, TX (US)

(21) Appl. No.: 17/069,819

(22) Filed: Oct. 13, 2020

Related U.S. Application Data
(63) Continuation-in-part of application No. 16/514,226, filed on Jul. 17, 2019.
(60) Provisional application No. 62/914,973, filed on Oct. 14, 2019.

(51) Int. Cl. G06F 12/0811; G06F 12/0891; G06F 12/06; G06F 12/1027; G06F 12/14; G06F 9/30; G06F 9/455

(52) U.S. Cl. CPC G06F 12/0811; G06F 12/0891; G06F 12/063; G06F 12/1027; G06F 2009/45583; G06F 9/30101; G06F 9/30047; G06F 9/45558; G06F 12/1441

(57) ABSTRACT

Examples provide a system that includes at least one processor; a cache; a memory; an interface to copy data from a received packet to the memory or the at least one cache; and controller to manage use of at least one region of the cache. In some examples, the controller is to: indicate availability of a cache region reservation feature; receive a request to reserve a region of the cache from a requester; and based on the requested region being permitted to be reserved by the requester, solely allow the requester to write data to at least a portion of the reserved region. In some examples, the controller is to write to a register to indicate availability of a cache region reservation feature. In some examples, the request to reserve a region of the cache from a requester comprises a specification of a number of sets, a number of ways, and a class of service.

### RELATED APPLICATIONS

The present application claims the benefit of a priority date of U.S. provisional patent application Ser. No. 62/914,973, filed Oct. 14, 2019, the entire disclosure of which is incorporated herein by reference.

The present application is a continuation-in-part to U.S. patent application Ser. No. 16/514,226, filed Jul. 17, 2019, and claims the benefit of a priority date of such application. The entire disclosure of such application is incorporated herein by reference.

### BACKGROUND

For telecommunication services, many service level agreements (SLA) are defined around latency oriented metrics, with performance requirements defined in a series of Service Level Objectives (SLOs). Services include, for example, voice over IP (VoIP), video conferencing, high frequency trading, real-time intrusion protection and detection systems, and so forth. In this environment, commonly shared resources such as last level cache, memory bandwidth or input/output (I/O) bandwidth are to be favored or prioritized for workloads. For example, a search engine provider has some service level objectives (SLO) where latency for web search workloads need to have guaranteed upper bound time. In order to achieve that SLO, the system is kept physically isolated, so resources are all available for queries. However, very low utilization in the data center racks and high total cost of ownership (TCO) can occur because the system resources are underutilized most of the time.

### BRIEF DESCRIPTION OF THE DRAWINGS

FIG. 1 depicts an example system.

FIG. 2A shows examples of a packet processing pipeline configurations.

FIG. 2B depicts an example of cache organizations.

FIG. 3 depicts an example system.

FIG. 4 depicts an example of a pseudo cache locking controller.

FIG. 5 depicts an example cache allocation system using a shared resource monitoring and control.

FIG. 6 depicts an example of a cache partition usage.

FIG. 7 shows an example operation of a platform.

FIGS. 8A-8C provide examples of eviction policies.

FIG. 9 depicts an example process.

FIG. 10 depicts a system.

FIG. 11 depicts an example of a data center.

### DETAILED DESCRIPTION

Packet processing workloads have similar and stringent requirements around latency. Packet data or information related to processing packets can be mapped to physical addresses that are mapped into a set in a cache. But data in the cache can be evicted which can lead to a long tail in response time. A deterministic latency for data in cache is preferred in some cases. Deterministic latency can refer to latency from accessing data from a cache, rather than from memory, and writing data to the cache (which introduces further latency). There is a trend that network micro-services running in containers and Virtual Machines (VMs) and the amount of context running on a single core are increasing. In order to provide deterministic latency, extending cache quality of service to high level cache hierarchy is crucial.

For situations where software-implemented operations require rapid access to data or instruction code, such data or instruction code can be stored in a cache. Accordingly, the use of a cache to store data is common in highly latency sensitive scenarios such as software defined network functions virtualization (NFV) operations, broadband remote access servers (BRAS), voice over IP (VoIP), 4G or 5G switching and routing, process execution at edge nodes, command of self-driving vehicles, content distribution networks (CDN), and others. Cache resources are limited such that processors and processor-executed software contend for precious cache resources and can cause eviction of data or code from the cache. Eviction of data or code from the cache can lead to non-deterministic execution times, which may lead to violation of applicable SLAs or SLOs.

For example, in Data Plane Development Kit (DPDK), there is a software flow cache, which is smaller than the main lookup table. The software flow cache is designed to track frequently used packet metadata, so the main (big) lookup table does not need to be visited/updated frequently. However, there is no hardware feature to pin this small flow cache in level 1 (L1) cache to attempt to reduce or control latency of availability of data in the small flow cache. For example, an incoming burst of new packets evicts the software flow cache further away from L1. This results in un-deterministic performance even when including small flow cache.

Intel® Resource Director Technology (RDT) can provide platform quality of service to attempt to provide deterministic performance. Intel® Resource Director Technology (RDT) allows partitioning of a last level cache between high priority processes and normal priority processes such that they can drive up system utilization without violating high priority process SLO. Intel® RDT provides a hardware framework to manage shared resource such as L3 cache (see, e.g., Intel® 64 and IA-32 Architectures Software Developer's Manuals Vol 3b. Chapter 17.15 and 17.16 for information on CMT, MBM, CAT, CDP and MBA). Intel® RDT includes Cache Monitoring Technology (CMT), Memory Bandwidth Monitoring (MBM) and Cache Allocation Technology (CAT). CMT can enable tracking of the L3 cache occupancy, enabling detailed profiling and tracking of threads, applications, or virtual machines. MBM feature can support two types of events reporting local and remote memory bandwidth. Reporting local memory bandwidth can include a report of bandwidth of a thread accessing memory associated with the local socket. In a dual socket system, the remote memory bandwidth can include a report the bandwidth of a thread accessing the remote socket. CAT can allow an operating system (OS), hypervisor, or virtual machine manager (VMM) to control allocation of a central processing units (CPU) shared LLC.

Locking cache lines and their content is one approach to ensuring content remains in the cache and is accessible. A known approach for locking a portion of a cache is available from ARM, which provides a way to lock down a portion of an instruction cache or data cache. However, this is limited only to locking of a Last Level Cache (LLC) and cannot be used to go further up in memory hierarchy. The ARM940T instruction and data caches comprise four segments, each with 64 lines of four words each. Each segment can be 1 KB in size. Lock down can be performed with a granularity of one line across each of the four segments and the smallest space which may be locked down is 16 words. Lock down starts at line zero and can continue until 63 of the 64 lines are locked. If there were more data to lock down, then at the final step, step 7, the DL bit should be left HIGH, Dindex incremented by 1 line, and the process repeated. The DL bit should only be set LOW when all the lock down data has been loaded.

A class of service (COS) constitutes of a number of ways of the last level cache. A CPU can be associated with a class of service, where reads from dynamic random access memory (DRAM) are filled into those cache ways associated with a class of service. But, this solution does not provide granularity to divide L2 cache with respect to ways and sets and control use of the L2 cache with respect to ways and sets.

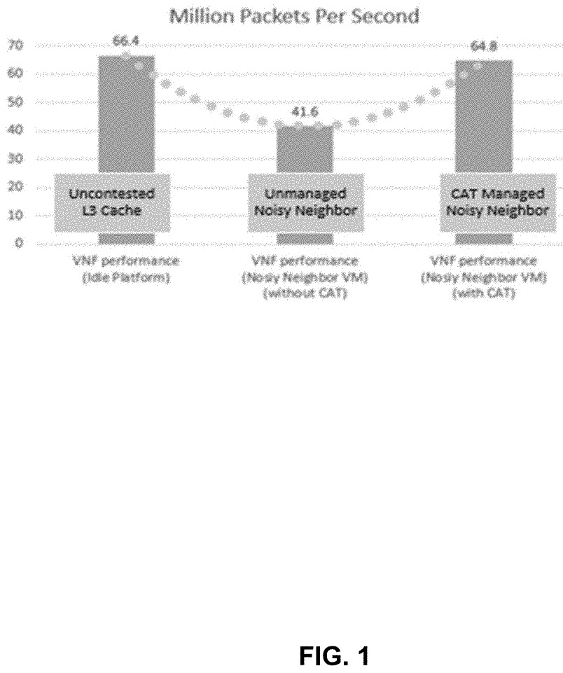

FIG. 1 shows VNF performance restoration using Cache Allocation Technology. For example, a network function virtualization (NFV) solution utilizes an off-the-shelf server with three types of VMs. VM#1(VNF VM) is an Intel® Data Plane Development Kit (DPDK) based VNF with the packet framework running in a guest VM. This VM demonstrates characteristics of real NFV VMs. VM#2(Aggressor VM) is an aggressor application VM whose purpose will be to use CPU's shared resources in such a way that it will adversely affect the VNF VMs (e.g., “Noisy Neighbor”). Using CMT and MBM features, L3 cache occupancy and memory bandwidth of all VMs running on the platform were monitored. These profiling statistics help detect the aggressor VM#2 as it is consuming all the shared resources causing performance drop for the high priority VM#1. CMT and MBM statistics help in setting an L3 cache allocation strategy for low priority VM and high priority VM. Based on LLC occupancy and memory bandwidth consumption, using CAT feature, 80% L3 cache is allocated to VM#1(High Priority application) and 20% of L3 cache is allocated for the VM#2 (Low Priority application).

As seen in FIG. 1, an idle platform receives 66.4 mega packets per second (MPPS) but as soon as Aggressor VM is launched, performance drops to 41.6 MPPS. After profiling both VMs using CMT, MBM and applying CAT, performance can increase to 66.4 MPPS with a Noisy Neighbor running. Once a set-up is performed, Intel® RDT feature can restore throughput performance in a noisy neighbor environment.

Currently there are instructions to manage the L1, L2 and L3 caches. For example, in Intel Architecture (IA), PREFETCHh, CLFLUSH and CLFLUSHOPT instructions, non-temporal moving instructions (MOVNTI, MOVNTQ, MOVNTDQ, etc.) and privileged instructions (INVD, WBINVD) can be used to manage various caches. These instructions enable flushing caches and forcing memory ordering. CLFLUSH and CLFLUSHOPT allow selected cache lines to be flushed from memory. Non-temporal move instructions allow data to be moved from processor's registers directly to the system memory. See, e.g., Intel® 64 and IA-32 Architectures Software Developer's Manuals Vol 3. Chapter 11.5 Cache Control.

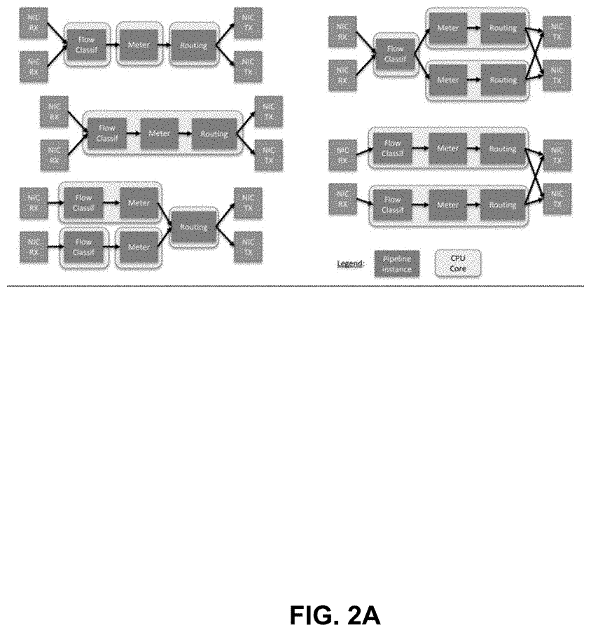

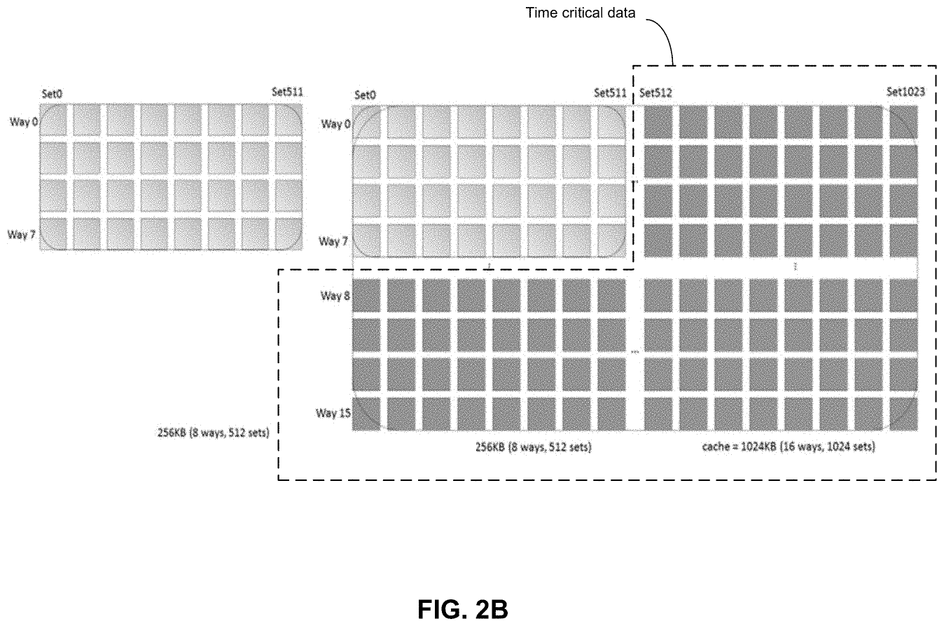

FIG. 2A shows examples of a packet processing pipeline configurations in a DPDK ip_pipeline where multiple cores are involved. Producer and consumer pairs can communicate through a software ring interface. These types of pipelines can include multiple cores acting as producers and consumers of data whereby data is processed by a producer and available for use or additional processing by a consumer.

FIG. 2B depicts an example of cache organizations. In FIG. 2B, darker colored ways and sets can be used to retain time critical data to reduce latency of processing such data. In some examples, a CPU can manage cache allocation for content that is time sensitive. With evolving architectures, a larger private cache can help applications such as image processing or deep learning algorithms by making available a larger sized L2 cache. In recent studies, private L2 cache sizes have increased from 256 KB to 1 MB, with increased numbers of ways and sets, but certain packet processing pipeline performances did not improve. For example, in a 1 MB L2 cache size configuration, there may be more cross-core snoops to determine if cache coherency is maintained among cache devices compared to a number of snoops for a 256 KB L2 cache size configuration. For packet processing scenarios, this could result in undesirable latency for network packet round trip time. In some cases, a higher number of cross-core snoops were due to more producer data retained in the private L2 cache, so a benefit of natural capacity eviction may not be used. With the cache ways doubling from 8 to 16, a capacity eviction may need more set conflict to evict data from its private cache. However, if the cache also doubles the set counts from 512 to 1024, set conflicts for the same data structure may reduce as well. Accordingly, multicore applications may experience performance degradation due to increased core to core snooping.

Various embodiments can extend platform quality of service by providing a system with ability to configure cache set and way allocation for use by an application, software (e.g., virtual machine or container), or device. Various embodiments include an application program interface or ability for a requester to use instruction set architecture (ISA) interface (e.g., single software interface or instruction) to request reserving a region of a cache (e.g., by number of sets and number of ways) without awareness of a microarchitecture of the cache. For example, a requester can include an application, virtual machine, orchestrator, or hypervisor. Various embodiments permit managing cached content in a monolithic cache as opposed to a specific cache region.

Various embodiments provide a cache that provides properties for software to leverage such as a region of working data set that can be guaranteed to be locked or reserved for deterministic packet lookup performance and a second region of a working data set to dynamically accommodate various cache data retention policies. Various embodiments can extend cache quality of service or class of service (COS) to one or more levels of cache hierarchy to attempt to provide deterministic latency for packet processing operations. Various embodiments provide a system and interface for software to size a region of cache by set and ways and allow a software developer to choose desired probabilities of data retention rate in a cache or data eviction from the cache. Various embodiments can apply to managing use of any of: a translation lookaside buffer (TLB), second level TLB, L2 TLB, L3 TLB, level-1 cache, level-3 cache, last level cache (LLC) cache, or decoded instruction stream cache. Various embodiments can apply to N-way set associative caches or other types of caches (e.g., direct mapped or fully associative).

Various embodiments can extend platform quality of service by providing an ability to configure cache set and way allocation to work alongside cache allocation technology (CAT) of RDT that provides for allocation of an LLC that is shared among cores. Different regions of a cache can be allocated for fetching of data by requesters.

Various embodiments provide a solution for use-cases such as cloud infrastructure, database queries and so forth. In a case of database query requests, a size of query does not necessarily need use of a large cache or overlapped case where a complete cache way is reserved. In other words, such use-case may use more granularity in terms of retaining very small or large data sets such as a database query (e.g., 64 bytes, 128 bytes to 1 Kbyte or so forth) in a shared resource. Various embodiments provide programmable features that allow control over cache reservation and retention policies to achieve better resource utilization and not oversubscribe cache size.

Various embodiments can be used to allocate cache to assist with meeting service level agreements (SLAs) for customers or data center providers or quality of service (QOS) for customers (e.g., wired or wireless telephone companies). For example, SLA requirements may include one or more of: application availability (e.g., 99.999% during workdays and 99.9% for evenings or weekends), maximum permitted response times to queries or other invocations, requirements of actual physical location of stored data, or encryption or security requirements.

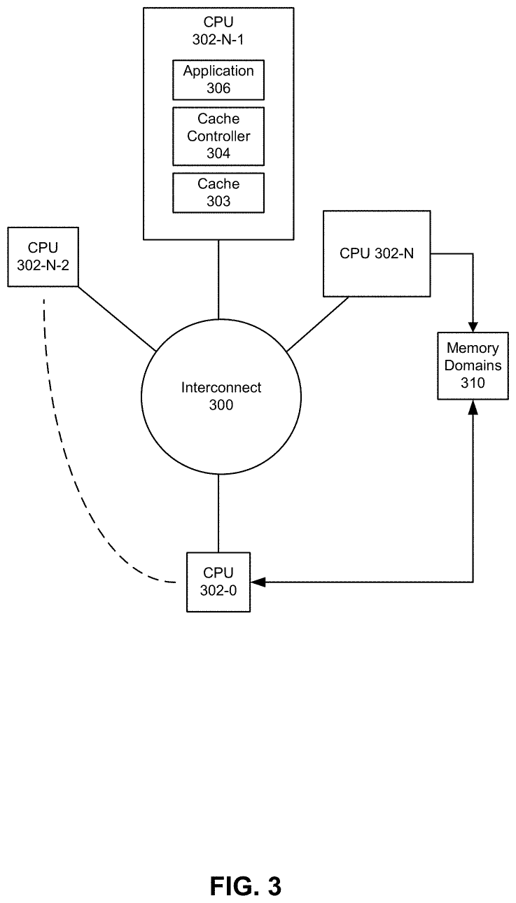

FIG. 3 depicts an example system. Various embodiments can be used to lock cache regions in a cache device. One or more central processing units (CPUs) 302-0 to 302-N can be communicatively coupled to an interconnect 300. Any CPU can include or use cache controller 304. In accordance with embodiments described herein, cache controller 304 can monitor and control locking of any region of a cache 303 (or TLB). A core of a CPU can execute a requester (e.g., application 306) or other software that requests locking of a region of a cache or indication of what portion of a cache be locked.

A core can include an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh.

Cache controller 304 can be implemented as a microcontroller, state machine, core that executes a process, fixed function device (e.g., field programmable gate array), and so forth. Cache controller 304 could be implemented in an uncore or system agent to provide a single unified interface. A system agent can include or more of a memory controller, a shared cache, a cache coherency manager, arithmetic logic units, floating point units, core or processor interconnects, or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

For example, applications 306 can include a service, microservice, cloud native microservice, workload, or any software. Any of applications 306 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments (e.g., VMs or containers). VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

A virtual execution environment (VEE) can include at least a virtual machine or a container. VEEs can execute in bare metal (e.g., single tenant) or hosted (e.g., multiple tenants) environments. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, FreeBSD, VMWare, or Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

Interconnect 300 can provide communications among CPUs 302-0 to 302-N. Interconnect 300 can be compatible at least with Intel QuickPath Interconnect (QPI), Intel Ultra Path Interconnect (UPI), Intel On-Chip System Fabric (IOSF), Omnipath, Ethernet, Compute Express Link (CXL), HyperTransport, high-speed fabric, PCIe, NVLink, Advanced Microcontroller Bus Architecture (AMBA) interconnect, OpenCAPI, Gen-Z, CCIX, Infinity Fabric (IF), and so forth. Although not shown, CPUs, cache devices, accelerators, and/or other devices may be connected to the high speed interconnect of interconnect 300. Other devices may include, for example, one or more memory devices (e.g., dual in-line memory modules (DIMMs)) hosting memories included in memory domains 310.

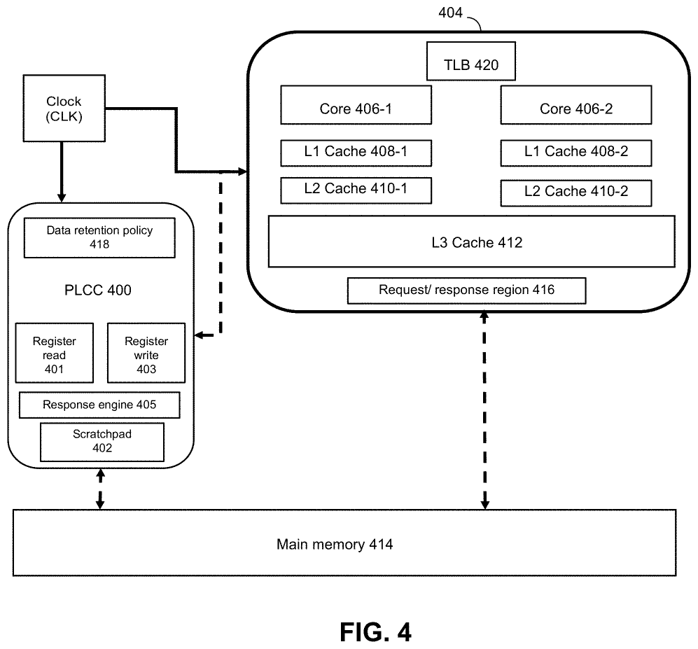

FIG. 4 depicts an example of a pseudo cache locking controller in accordance with some embodiments. Pseudo-locking cache controller (PLCC) 400 can facilitate cache locking throughout any level of a cache. Controller 400 can be assigned by an operating system (OS) or privileged thread to be responsible for locking a portion of any of L1, L2, L3, LLC, TLB 420, or decoded instruction stream cache. Other portions of L1, L2, L3 or TLB can be locked by the OS. However, locking of regions of a cache or TLB by controller 400 can be overridden by the OS or some commands or functions such as write back and invalidate (WBINVD) or power management. In some examples, if a cache line is locked using a lock bit, such lock bit is not used to lock a region of cache or TLB assigned to controller 400. Instead, controller 400 can lock a region by designating a region locked in scratch pad 402 and treating the region as locked to requests to lock the region. However, in some embodiments, controller 400 can lock a region by designating a region locked in scratch pad 402 and also lock the region using lock bits.

Controller 400 can allow any cache or TLB 420 to be locked to achieve greater level quality of service (QoS) for performance of requesters or threads as executable code or data are stored in cache and readily available for access. Any level of cache can include code or data cache, translation lookaside buffer (TLB) 420, L1 cache, L2 cache, and/or L3 cache.

Controller 400 can provide a programmable interface to lock or unlock a region of a cache (e.g., L1, L2, L3), TLB and so forth. For example, request/response region 416 can be used to write requests, read requests, write responses, or read responses. Using the programming interface, a requester or device can request that controller 400 lock a region of a cache or TLB 420 by at least specifying dimensions (e.g., bottom and top of range) of the cache region to lock. The requester can request to lock the region for use to store workloads, executable binaries, un-compiled instructions, complied instructions, or data, or for any uses.

For example, TLB 420 can store virtual-to-physical address translations. Controller 400 can lock contents of TLB 420 to allow for locking of certain virtual-to-physical mappings. For example, a virtual-to-physical mapping can be locked to ensure its availability when a translation is needed. For example, if executable instructions are stored in a cache and the instructions reference other code (e.g., branches, jump, subroutine), then locking of the virtual-to-physical mapping in the TLB can allow for availability of virtual-to-physical address mapping to the other code without having to perform an address translation operation.

Request/response region 416 can be one or more of model specific register (MSR), memory-mapped I/O (MMIO), memory type range registers (MTRRs), model specific registers (MSRs), shared memory region (including virtual memory), and/or register files. For example, to write or read from MSRs, wrmsr or rdmsr instructions can be used. An MSR can include control registers used for program execution tracing, toggling of compute features, and/or performance monitoring. The MSR can include one or more of: memory order buffer (MOB) control and status; page fault error codes; clearing of page directory cache and TLB entries; control of the various cache memories in the cache hierarchy of the microprocessor, such as disabling portions or all of a cache, removing power from portions or all of a cache, and invalidating cache tags; microcode patch mechanism control; debug control; processor bus control; hardware data and instruction pre-fetch control; power management control, such as sleep and wakeup control, state transitions as defined by ACPI industry standards (e.g., P-states and C-states), and disabling clocks or power to various functional blocks; control and status of instruction merging; ECC memory error status; bus parity error status; thermal management control and status; service processor control and status; inter-core communication; inter-die communication; functions related to fuses of the microprocessor; voltage regulator module VID control; PLL control; cache snoop control; write-combine buffer control and status; overclocking feature control; interrupt controller control and status; temperature sensor control and status; enabling and disabling of various features, such as encryption/decryption, MSR password protection, making parallel requests to the L2 cache and the processor bus, individual branch prediction features, instruction merging, microinstruction timeout, performance counters, store forwarding, and speculative table walks; load queue size; cache memory size; control of how accesses to undefined MSRs are handled; multi-core configuration; configuration of a cache memory (e.g., de-selecting a column of bit cells in a cache and replacing the column with a redundant column of bit cells), duty cycle and/or clock ratio of phase-locked loops (PLLs) of the microprocessor, and the setting voltage identifier (VID) pins that control a voltage source to the microprocessor.

In some example, caches (e.g., Intel architecture caches) are organized in the form of ways and sets, however cache accessibility can use semantics other than N way set associative such that a subset of a cache can be reserved for control by a cache lock controller. A requester executing on a core can query controller 400 for a cache region that is available to lock and the requester can check the status of cache locking and decide what region of cache to request based on available lockable cache specified according to ways and sets. An interface can be provided to specify how much of each cache level can be allocated for control by controller 400. For example, a model specific register (MSR) interface, register, or an interface on the controller itself could be used to specify how much of each cache level is allocated for control by controller 400.

Register read logic 401 can read instructions in request/response region 416. Response engine 405 can interpret instructions in request/response region 416 and form a response. For example, for an instruction to lock a cache region in request/response region 416, response engine 405 can interpret the response and acknowledge receipt of the instruction via use of register write 403 to request/response region 416. Response engine 405 can lock a region of cache or TLB based on indications in scratch pad 402 of unlocked regions in cache or TLB. Response engine 405 can write a response to request/response region 416, using response engine 405, where the response indicates a request to lock a region of cache is granted at least based on the request identifying a region of cache or TLB that is not identified as locked in scratch pad 402. Response engine 405 can be implemented as software executed by a processor and/or a hardware device. In some examples, response engine 405 can be implemented in a network interface device that uses or accesses a cache or TLB.

Scratch pad 402 can be a table that tracks what portions of a cache subsystem are occupied and what is available for locking or occupation. For example, a scratch pad size of up to 8 kilobytes can accommodate various cache hierarchies to track occupied or unoccupied cache areas that can be locked or unlocked. Scratch pad 402 can be a table stored in a register, cache, memory, or storage. For example, a portion of scratch pad 402 can be stored in an associated level of a cache resource referred to by the portion. Various non-limiting formats of a scratch pad are described herein.

Data retention policy 418 can be set by a requester for locked regions of cache or TLB. A data retention policy sets an eviction or flushing policy for the locked content. For example, a policy can be fast eviction is permitted, slow is required, or balanced eviction. Controller 400 can be configured to not allow locked regions under its control to be evicted by eviction policies.

Controller 400 can be coupled to one or more central processing units (CPUs) by use of an interconnect (e.g., PCIe), bus, mesh, fabric, motherboard, or any connectivity. In this example, controller 400 is coupled to control caches of CPU 404 and CPU 404 includes cores 406-1 and 406-2 and associated caches. For example, core 406-1 can access (e.g., read from or write to) at least L1 cache 408-1, L2 cache 410-1, and L3 cache 412. Core 406-2 can access (e.g., read from or write to) at least L1 cache 408-2, L2 cache 410-2, and L3 cache 412. Although in other implementations, a cache can be shared by one or more cores. Controller 400 can monitor locking and permit locking at least of L1 cache 408-1, 408-2, L2 cache 410-1, 410-2, and L3 cache 412. In some examples, in addition to controller 400, a root complex integrated endpoint manages locking or unlocking of the L3 cache.

Main memory 414 can be a memory device or devices that are locally connected to controller 400 and CPU 404 or remotely accessible via a bus, interconnect, or network. Main memory 414 can store any content (e.g., data, executable code, binaries, byte codes, and so forth) that is to be written to any cache or cache content can be flushed to main memory 414. Note that main memory 414 can represent physical and/or virtual memory regions and/or pools of memory devices, including distributed memory pools.

Controller 400 can be implemented as a microcontroller, state machine, core that executes a process, fixed function device (e.g., field programmable gate array), and so forth. Controller 400 could be implemented in an uncore or system agent to provide a single unified interface. A system agent can include or more of a memory controller, a shared cache, a cache coherency manager, arithmetic logic units, floating point units, core or processor interconnects, or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

In some examples, a thread or instance of controller 400 can be assigned to a different portion of cache or level of cache or TLB and each thread or instance is responsible for locking or unlocking regions in that portion. Accordingly, multiple different threads or instances of controller 400 can be used to manage a different portion of a cache or TLB. The threads or instances of controller 400 can operate independently or in parallel.

### Components for Cache Allocation

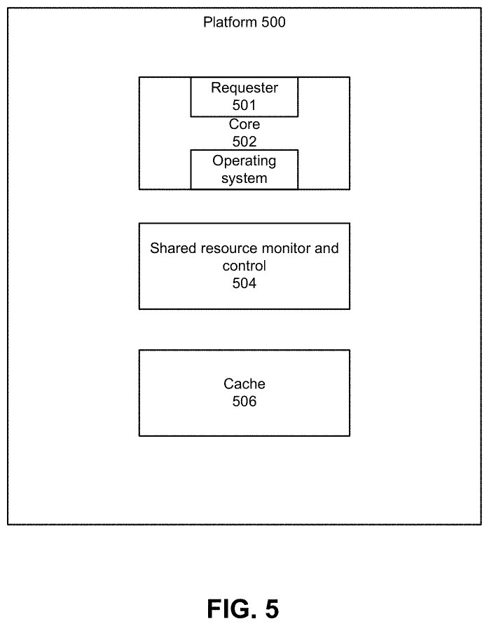

FIG. 5 depicts an example cache allocation system using a shared resource monitoring and control. In platform 500, core 502 can execute a requester 501, operating system, driver, or other software. In some examples, shared resource monitoring and control system 504 can provide resource allocation capabilities to control over how resources such as cache 506 and memory bandwidth are used by requester 501. For example, requester 501 can include an application, virtual machine, container, orchestrator, hypervisor, or other software. For example, an orchestrator can provide configuration, coordination, and management of hardware and software resources in a server, rack of servers, data center, edge node, or others. In some examples, core 502 can execute one or more threads, where a thread executes a process, application, container, or virtual machine. Core 502 can execute multiple threads concurrently.

An identifier, such as a CPUID, can be used to identify the presence of the architectural version of monitoring and allocation feature sets available for use by shared resource monitoring and control system 504. For example, at boot of a platform, an operating system can enumerate available features based on indication of available features by devices, including shared resource monitoring and control system 504. For example, shared resource monitoring and control system 504 can write a CPUID to a register to indicate availability of a cache reservation feature and the OS reads register and determine such feature is available.

For example, shared resource monitoring and control system can include any feature set of Intel® Resource Director Technology (RDT) such as one or more of Cache Allocation Technology (CAT), Code and Data Prioritization (CDP), Memory Bandwidth Allocation (MBA), Cache Monitoring Technology (CMT), and Memory Bandwidth Monitoring (MBM). Shared resource monitoring and control system 504 can use tags such as Resource Monitoring IDs (RMIDs) and class of service (CLOS), and instruction enumeration (e.g., processor supplementary instruction (e.g., CPUID-based) and MSR-based interfaces in order to indicate to an operating system or requester 501 that the operating system or requester 501 can set a region of cache 506 so that the content in the reserved region is not evicted or subject to an eviction policy.

For example, CAT can provide software-guided redistribution of cache capacity, enabling important data center requesters to benefit from improved cache capacity and reduced cache contention. CAT can provide an interface for the OS/hypervisor to group requesters into classes of service (CLOS) and indicate the amount of last-level cache available to each CLOS. These interfaces can be based on MSRs (Model-Specific Registers). CAT may be used to enhance runtime determinism and prioritize important requesters such as virtual switches or Data Plane Development Kit (DPDK) packet processing apps from resource contention across various priority classes of workloads.

For example, CDP can provide separate control over code and data placement in the last-level (L3) cache. Certain specialized types of workloads may benefit with increased runtime determinism, enabling greater predictability in application performance.

For example, MBA can provide control over memory bandwidth available to workloads, enabling new levels of interference mitigation and bandwidth shaping for “noisy neighbors” present on the system.

For example, CMT can provide monitoring of last-level cache (LLC) utilization by individual threads, applications, VMs, or containers, CMT improves workload characterization, enables advanced resource-aware scheduling decisions, aids “noisy neighbor” detection and improves performance debugging.

For example, MBM can provide monitoring of multiple VMs, containers, or applications can be tracked independently via Memory Bandwidth Monitoring (MBM), which provides memory bandwidth monitoring for each running thread simultaneously. Benefits can include detection of “noisy neighbors,” characterization and debugging of performance for bandwidth-sensitive VMs, containers, or applications, and more effective non-uniform memory access (NUMA)-aware scheduling.

For example, after cpuid.(eax=07h, ecx=0h).ebx[15]==1, at least one allocation technology supported on the processor has been verified, and CPUID leaf 0x10 and sub-leaves provide further details on a feature (e.g., CAT feature) such as mask lengths available. According to various embodiments, a cache lock feature set can be enumerated by a CPUID leaf (e.g., parameters or fields of the CPUID) to expose to an operating system or requester 501: (a) whether a platform supports an L2SW feature described herein, (b) maximum number of available L2SW class of services (CLOSs) or COS supported, (c) maximum number of available L2SW CLOSs; (d) a maximum number of available L2SW ways to configure; or (e) a maximum number of available L2SW sets to configure. A maximum number of available L2SW CLOSs can be finite and based on hardware capacity and this enumeration can be dependent on hardware implementation limitations for a maximum number of CLOS s. For example, availability to utilize a cache lock feature set can be provided in registers (e.g., EAX, EBX, ECX, and EDX registers). According to some embodiments, reserving or locking a region of the cache permits the requester to exclusively write to the reserved region and can permit the requester to read from the reserved region. According to some embodiments, reserving or locking a region of the cache permits the requester to exclusively write to the reserved region and can permit the requester and one or more other requesters to read from the reserved region.

A Class of Service (CLOS) can provide a resource control tag and a thread can be associated with a CLOS. The CLOS can have an associated resource capacity indicator that indicates how much of a cache can be used by a given CLOS. A platform can perform CPUID enumeration to gather a global pool of available CLOSs. These constructs can be further used by multiple requesters to request L2 cache allocation. Within a requester, a developer can indicate a priority level of data and there can be higher priority uses of data and lower priority levels of data. In some examples, the CLOS can refer to a priority level of the requester. For example, a software developer can program a CLOS way mask and CLOS sets in a requester executed by a thread. An L2 cache allocation size request can be dynamically changed by a developer. A number of ways versus number of sets can be set based on programming guidelines such as those described with respect to Tables 1-3 described herein.

For example, shared resource monitoring and control system 504 can provide separate control over code and data placement in cache 506. Certain specialized types of workloads may benefit from increased runtime determinism, enabling greater predictability in requester performance. For example, shared resource monitoring and control can provide tracking of multiple requesters independently via Memory Bandwidth Monitoring (MBM), which can provide memory bandwidth monitoring for each running thread simultaneously. Benefits can include detection of noisy neighbors, characterization and debugging of performance for bandwidth-sensitive requesters, and more effective non-uniform memory access (NUMA)-aware scheduling. NUMA can include a memory configuration where memory access time is based on memory location relative to a processor.

A requester (e.g., requester 501) can configure or access shared resource monitoring and control system 504 to reserve a region of cache 506 using one or more of SIOV, SR-IOV, MR-IOV, or PCIe transactions. For example, shared resource monitoring and control system 504 can be presented as a physical function (PF) to any server or requester. In some examples, platform 500 and shared resource monitoring and control system 504 can support use of single-root I/O virtualization (SR-IOV). PCI-SIG Single Root IO Virtualization and Sharing Specification v1.1 and predecessor and successor versions describe use of a single PCIe physical device under a single root port to appear as multiple separate physical devices to a hypervisor or guest operating system. SR-IOV uses physical functions (PFs) and virtual functions (VFs) to manage global functions for the SR-IOV devices. PFs can be PCIe functions that can configure and manage the SR-IOV functionality. For example, a PF can configure or control a PCIe device, and the PF has ability to move data in and out of the PCIe device.

In some examples, platform 500 and shared resource monitoring and control system 504 can interact using Multi-Root IOV (MR-IOV). Multiple Root I/O Virtualization (MR-IOV) and Sharing Specification, revision 1.0, May 12, 2008, from the PCI Special Interest Group (SIG), is a specification for sharing PCI Express (PCIe) devices among multiple computers.

In some examples, platform 500 and shared resource monitoring and control system 504 can support use of Intel® Scalable I/O Virtualization (SIOV). A SIOV capable device can be configured to group its resources into multiple isolated Assignable Device Interfaces (ADIs). Direct Memory Access (DMA) transfers from/to each ADI are tagged with a unique Process Address Space identifier (PASID) number. Unlike the coarse-grained device partitioning approach of SR-IOV to create multiple VFs on a PF, SIOV enables software to flexibly compose virtual devices utilizing the hardware-assists for device sharing at finer granularity. Performance critical operations on the composed virtual device can be mapped directly to the underlying device hardware, while non-critical operations can be emulated through device-specific composition software in the host. A technical specification for SIOV is Intel® Scalable I/O Virtualization Technical Specification, revision 1.0, June 2018.

For example, shared resource monitoring and control system 504 can provide software-guided distribution or redistribution of cache capacity, enabling requesters to benefit from improved cache capacity and reduced cache contention and to enhance runtime determinism. Requesters can be prioritized, such as virtual switches or Data Plane Development Kit (DPDK) packet processing requesters, from resource contention across various priority classes of workloads.

For example, shared resource monitoring and control system 504 can monitor the last-level cache (LLC) utilization by individual threads or requesters to provide workload characterization, enable advanced resource-aware scheduling decisions, and assist with “noisy neighbor” detection and improve performance debugging.

Various embodiments of shared resource monitoring and control system 504 can resolve first order contention of shared level resource, e.g., L2 cache between two hardware threads. A thread can include a sequence of processor-executed instructions. In some examples, a per-thread tag (e.g., Class of Service (CLOS) tag) can be associated with a thread. The per-thread tag can be stored in a control register, stored in an MSR, or based on a thread ID or core ID. The tag could identify (e.g., point to) a particular portion of cache, using a descriptor, and so forth, and with an enumeration process (perhaps a different set of bits in CPUID, MSR bits, or family/model/stepping-based detection of support).

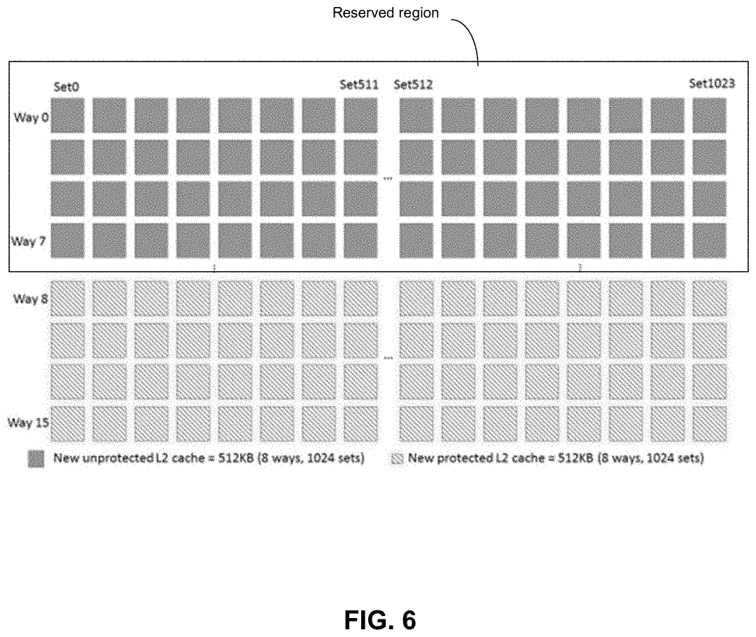

FIG. 6 depicts an example of a proposed L2 cache partition usage. A requester can request to lock the reserved region so that the content in the reserved region is not evicted or subject to an eviction policy.

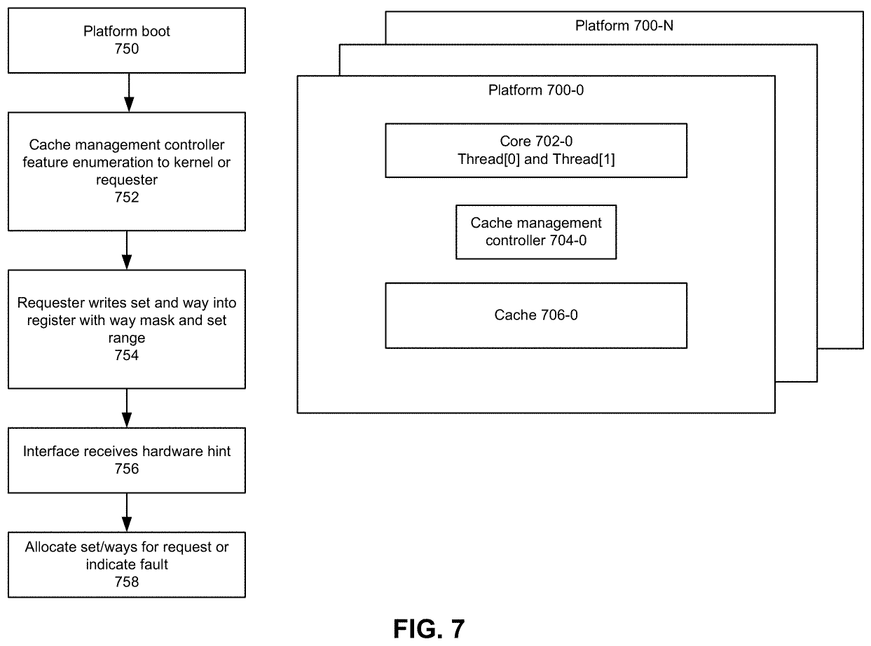

FIG. 7 shows an example operation of a platform. In this example, a platform 700-0 can utilize core 700-0 to execute threads[0] and [1], although one or more than one thread can be executed. In some examples, a thread can be executed in an environment that permits simultaneous multithreading (e.g., Intel® Hyper-threading technology). Cache management controller 704-0 can be accessed by an executed thread to allocate a region of cache 706-0 (e.g., TLB, second level TLB, L2 TLB, L3 TLB, level-1 cache, level-3 cache, last level cache (LLC) cache, or decoded instruction stream cache) for use by the executed thread. For example, an example operation of platform 700-0 can be as follows. At 750, a platform can boot-up and execute an operating system (OS). At 752, an L2SW allocation feature can be allocated to an OS or requester. In some examples, the OS can determine an L2 set-way (L2SW) allocation feature of cache management controller 704-0 is enabled in platform 700-0, in accordance with various embodiments. For example, cache management controller 704-0 can write to a register to inform software (e.g., OS or requester) that there is a cache locking capability available for use. For example, a register can enumerate platform reservation or locking of particular sets and/or ways of cache 706-0. In some examples, an L2SW feature set details can be identified as available using one or more of model specific register (MSR), memory-mapped I/O (MMIO), memory type range registers (MTRRs), shared memory region (including virtual memory), and/or register files. An MSR can be a state space can be used to configure hardware with numerous MSRs available and can be accessed using read and write instructions. Examples of MSR are described herein.

At 754, a requester can request to reserve or lock a region of a cache. A CPUID instruction issued by cache manager to write to registers and register inform a requester that cache reservation is available. A requester executed by a thread can request use of an L2SW feature and reserve a region of cache 706-0 to reserve content in the region to avoid higher latencies if the content is evicted to memory or storage and subsequently copied back to cache 706-0 or at least provide predictable latency for access to content in the region. For example, a requester can provide parameters L2SW_SET_OS#, L2SW_WAY_COS# to reserve a set and way range in cache 706-0. The requester can use registers to configure and reserve a set and way range in cache 706-0. For example, activity 754 can include the 754A to 754C (not depicted).

At 754A, a class of service (CLOS) can be configured a requester to define an amount of space in cache 706-0 available via MSRs for a set and way range. A priority level can be used by cache management controller 704-0 to set an amount of set and ways to be reserved by a requester. A management framework (e.g., a daemon or software interface) can convert parameters L2SW_SET_COS#, L2SW_WAY_COS# from the requester into corresponding set and way values and write the values into an MSR or registers. Sets and ways can be converted to commands and placed in appropriate MSRs. Example formats for defining set and way to MSRs or registers are described later.

At 754B, a determination can be made of an amount of cache specified in 754A that is to be locked or reserved. For example, 754B can be initiated by providing two hints in a critical section or working data set. A requester can provide L2SW_FILL_OPEN to lock a reservation of a region of cache 706-0. L2SW_FILL_OPEN set to “1” can indicate that working data set followed by the MSR set event will fill in a region of cache 706-0 specified for the hardware thread and can lock an attempt to reserve a region of cache.

At 754C, a logical thread (or core) can be associated with an available locked region of cache. The locked region of cache 706-0 can be associated with a thread or core that runs the requester that locked the region of cache. At 756, a microcode executed by cache management controller 704-0 or an MSR interface can receive a hardware hint that requested locked sets and ways are written into an MSR. A writing of an MSR (e.g., fill open) can trigger a check for available set and ways in cache 706-0. At 758, processor-executed microcode or an MSR can allocate set and way of request, if the set and way is available. A policy arbiter or daemon executed by cache management controller 704-0 can determine a grant allocation or not grant the allocation based on priorities or policies for a requester that requests a set or way. If the requested set or way is granted, a pass or a fail (e.g., general protection exception (GP#)) can be issued by cache management controller 704-0 if the requested set or way is not granted. In some examples, if an entirety of the requested set and way region is not available to reserve, the request is denied. Other examples grant a largest available region that is less than a size of the requested region.

After asserting L2SW_FILL_OPEN to “1,” a requester can provide L2SW_FILL_CLOSE to unlock a reservation of a region of cache 706-0. L2SW_FILL_CLOSE can be asserted after the requester finished processing the data and the region can be unlocked and available for use by other parts of the requester or another requester. L2SW_FILL_CLOSE set to “1” can indicate that the fill mechanism can fall back to default CLOS and can permit an attempt to reserve a region of cache by another requester or thread (or the same requester or thread). Use of L2SW_FILL_CLOSE can allow hardware to allow filling cache with content requested to be stored in formerly reserved set/way. Hence, data preservation can be achieved and no cache thrashing in the reserve region of cache 706-0 may occur at least due to a requester running on a same hardware thread.

In some examples, CLDEMOTE can be used to demote content from the reserved region of cache 706-0 to a shared cache region (e.g., LLC).

Various embodiments provide hardware assisted sets and ways allocation for a last level cache (LLC) to provide finer granularity to retain data in LLC. If an LLC can be sliced from one address domain whereby a memory address range is divided into a slices and cache lines receive content from a slice. An address decoder parallel to a source address decoder (SAD) can be used so that sets/ways allocation messages can be reliably provided to specific LLC slice and enforce sets ways allocation scheme. A scratchpad memory can be used to track addresses of memory regions that are reserved or not reserved.

The following describes example MSR constructs to define COS and Set and Way requested to be allocated. An operating system (OS), virtual machine manager (VMM), or requester may either allow the controller to manage underlying details of the caches such as sets or ways or may take charge and manage that mapping depending on the implementation.

MSR#_SET_L2SW: # are the total number of sets, Range: {0-1023}

TABLE 1

| | | | | Hardware | |
|---|---|---|---|---|---|
| | | | Attri- | Reset | Example |
| Name/Field | Range | Bits | bute | Value | Description |
| Start | 0-1023 | 0-9 | Read | 0 | Start of the sets |
| | | | Write | | to be locked |
| | | | (RW) | | |
| End | 0-1023 | 10-19 | RW | 0 | End of the sets |
| | | | | | to be locked |
| COS | 0-31 | 20-25 | RW | 0 | N number of |
| | | | | | possible ways |
| Expand | 0-1 | 26 | RW | 0 | See table below |
| (Policy) | | | | | for examples |
| | | | | | of eviction |
| | | | | | policies |
| Thread | Total | 30-27 | Write | 0 | Associate this |
| Groups | Cores in | | Once | | COS with a core |
| Association | a group | | | | or set of cores |
| | of 4 | | | | |
| Access | 0-1 | 31 | Write | 0 | Private or public |
| Level | | | Once | | to group. |
| | | | | | When set to private, |
| | | | | | GPF on illegal |
| | | | | | access by other |
| | | | | | threads in same group |
| | | | | | or other group |

MSR#_WAY_L2SW: # are total number of ways, Range: {8-15}

TABLE 2

| | | | | HW | |
|---|---|---|---|---|---|
| | | | Attri- | Reset | Example |
| Name/Field | Range | Bits | bute | Value | Description |
| Start | 8-15 | 0-3 | RW | 0 | Start of ways |
| | | | | | to be locked |
| End | 8-15 | 7-4 | RW | 0 | End of ways |
| | | | | | to be locked |
| Expand | 0-1 | 8 | RW | 0 | See table |
| (Policy) | | | | | for policy |
| Mask_N | N | | RW | | |

A cache controller can be programmed to have cache sets and ways with specified data retention rate levels. For example, a requester developer can specify data retention rate levels in any cache level or TLB. Table 3 provides an example of fields that can be used to set a data retention policy in an MSR.

TABLE 3
Data Retention Policy

| MSR#_SET_L2SW | MSR#_WAY_L2SW | |
|---|---|---|
| Expand field (Policy) | Expand field (Policy) | Policy |
| 0 | 0 | Unlocked Region |
| 1 | 0 | Protected and locked |
| | | (not subject to any |
| | | eviction) |
| 0 | 1 | Subject to possible |
| | | eventual eviction |
| 1 | 1 | Subject to eviction only |
| | | by other locked data in |
| | | case of contention |
| | | which software deems |
| | | acceptable |

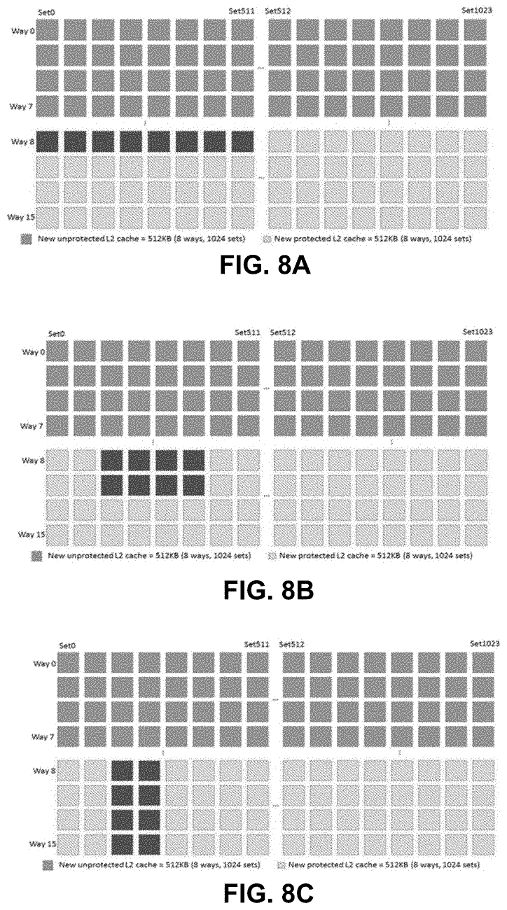

With respect to the data retention policies of Table 3, FIGS. 8A-8C provide examples of fast (unlocked), balanced (Protected and locked or Subject to possible eventual eviction), and priority (slow) (Subject to eviction only by other locked data) eviction. A requester developer can request a slow eviction rate for its data or code that is most time critical, fast eviction for content that is least time critical, or balanced for moderately time critical content. A processor causes data copying into the cache with cache lines (e.g., n bytes at a time). When a set is expandable and way is fixed, it is evicted faster to be replaced by another cache line. However, when a set is fixed, and ways are expanding, the reserved block will evict slower. FIG. 8A shows allocation of 512 cache lines from single way helps to promote capacity eviction. For a slow (priority) eviction rate, in an N ways and M set, N is much smaller than M.

FIG. 8B shows allocating 512 cache lines from 4 ways and 256 sets provides a balance for data retention as well as slightly above average eviction rate. For a balanced eviction rate, in an N ways and M set, N is approximately equal to M.

FIG. 8C shows allocating 512 cache lines from 8 ways and 128 sets provides longest data retention rate. For a slow (priority) eviction rate, in an N ways and M set, N is much larger than M.

Example code segments below show an example of how an L2 Cache Set Way allocation can be used. Using a set of MSRs, CLOS can be programmed to define a boundary for L2 cache partition information. This CLOS MSR can provide flexibility to program cache partition information dynamically.

// sample code which need not be locked into L2
:
:
WRMSR (MSR_L2SW_SET_COS 1 (START=0, END=15));
WRMSR (MSR_L2SW_WAY_COS1 (Mask=0x0001))
//working data set of size 1024 that needs to be locked in L2 set/ways BEGINS//~~~
WRMSR (MSR_L2SW_FILL_OPEN=1)
WRMSR (MSR_L2SW_PQOR_ASSOC=1)
for (size=0; <1024;size++)
flow1 [size]= INPUT_VALUE;

// assign allocated sets / ways and locks region while being allocated

WRMSR (MSR_L2SW_FILL_CLOSE=1)
:
: // code here which need not be locked into L2
WRMSR (MSR_L2SW_SET_COS2 (START=0, END=1))
WRMSR (MSR_L2SW_WAY_COS2 (Mask=0x0003))
//working data set of size 256 that needs to be locked in L2 set/ways BEGINS//~~~
WRMSR (MSR_L2SW_FILL_OPEN=1)
WRMSR (MSR_L2SW_PQOR_ASSOC=2)
for (size=0; <256;size++)
flow2 [size]= INPUT_VALUE;
WRMSR (MSR_L2SW_FILL_CLOSE=1)
:
: // code here which need not be locked into L2
:
:
WRMSR (MSR_L2SW_SET_COS1 (START=0, END=15))
WRMSR (MSR_L2SW_WAY_COS1 (Mask=0x0003))
//working data set of size 1024 that needs to be locked in L2 set/ways BEGINS//~~~
WRMSR (MSR_L2SW_FILL_OPEN=1)
WRMSR (MSR_L2SW_PQOR_ASSOC=1)
for (size=0; <1024;size++)
flow1 [size]= INPUT_VALUE;
WRMSR (MSR_L2SW_FILL_CLOSE=1)
:
: // code here which need not be locked into L2

//L2SW_COS0 CAN BE ALWAYS RESERVED BY THE SYSTEM, THIS IS DEFAULT COS for all threads. Some COS can be reserved by certain priority threads or never reserved.

For example, a stock trading application with highly traded set of stock tickers hash information linked to its database in a low latency highly available cache which would be cached for longer time. The following code could be used assert to a request to lock a region of cache of stock ticker related data. Embodiments are not limited to this example. Command “WRMSR” provides for writing the MSR with specified fields.

//Assign slow eviction rate policy, Set expand bit is 0 and Ways expand bit is 1
WRMSR (MSR_L2SW_SET_COS1 (START=0, END=15, Expand=0))
//Define class of service for Ways, and policy
WRMSR (MSR_L2SW_WAY_COS1 (Expand=1, Mask=0x0003))
WRMSR (MSR_L2SW_SET (ThreadGroup=1)
WRMSR (MSR_L2SW_SET (AccessLevel=1)
//Have working data sets of top 1000 tickers hashes linked to the database locked in L2
WRMSR (MSR_L2SW_FILL_OPEN=1)
WRMSR (MSR_L2SW_PQOR_ASSOC=1)
for (size=0; <1024;size++)
flow1 [size]= INPUT_VALUE;
WRMSR (MSR_L2SW_FILL_CLOSE=1)
:
:

For database queries like querying among top 1000 tickers, the hash information can always be kept in the L2 cache.
SELECT COUNT(*)
WHERE TICKER_NAME=‘XYZ’;

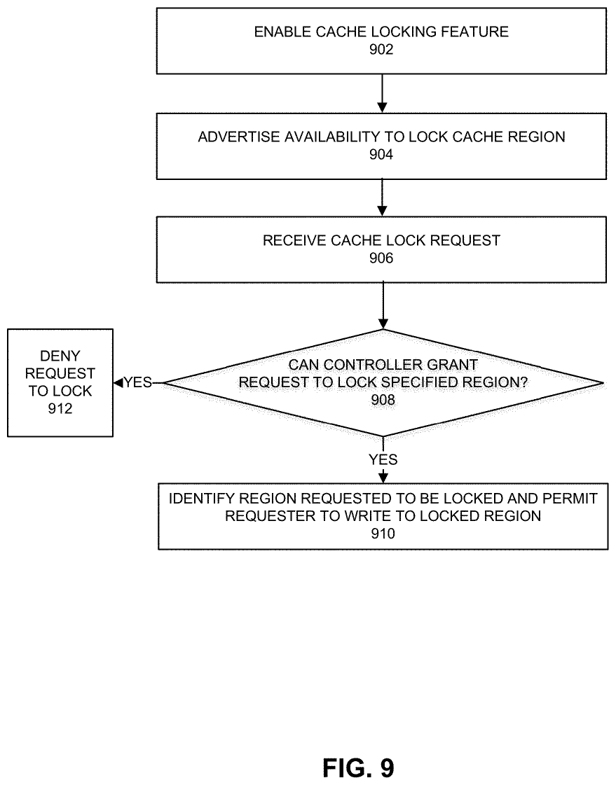

FIG. 9 depicts an example process. At 902, an L2 set-way (L2SW) allocation feature can be enabled architecturally in a system. For example, the L2SW allocation feature can be enabled as a platform boots an operating system (OS). For example, enablement and initialization can include operating system (OS) enablement or writing to model specific register (MSR) in user space to establish access level and thread group association. A cache can be one or more of: a translation lookaside buffer (TLB), second level TLB, L2 TLB, L3 TLB, level-1, level-2, level-3, last level cache (LLC), or decoded instruction stream cache.

At 904, availability of a cache region locking feature can be advertised to a kernel or requester. For example, a CPUID instruction can be used by the architecture to inform software (e.g., kernel or requester) that there is a cache locking capability. CPUID can enumerate availability for the platform to lock particular sets and ways of a cache. In some examples, L2SW allocation feature set details can be identified as available using one or more of model specific register (MSR), memory-mapped I/O (MMIO), memory type range registers (MTRRs), shared memory region (including virtual memory), and/or register files.

At 906, a configuration of a cache lock region can be received from software that is permitted to lock a region. For example, a requester can use instructions L2SW_SET_COS#, L2SW_WAY_COS# to reserve a set and way range. The requester can use registers to configure and reserve set and way range in a cache. For example, the requested locked region can be specified using sets/ways. A set can identify a column of a cache whereas a way can identify row of a cache. The instructions identifying a region requested to be locked can be written into a register in some examples.

At 908, a check be performed to determine if the requested region can be locked. If writing to the requested set/way is granted, at 910, indication can be provided of successful lock and the requester is permitted to write data into the locked cache region. If writing to the requested set/way is not granted, at 912 a denial or fail can be indicated to the requester. For example, a general fault can be issued if writing to the requested set/way is not granted. Writing to the requested set/way may not be granted, for example, because the region is locked or the requester's data does not have high enough priority to reserve the requested region. If the request is not granted, a requester can retry but with a smaller requested region.

In some examples, based on measured performance of application (e.g., compliance or non-compliance with SLA requirements), an orchestrator can tame a noisy neighbor that accesses or utilizes a region of a cache by restricting cache use of the noisy neighbor. For example, if a first requester is determined to utilize more cache region than a second requester and the performance (e.g., packet processing latency) is not sufficient but the performance (e.g., packet processing latency) of the first requester is sufficient, then an amount of cache region reservable by the first requester may be reduced to allow more cache reservation by the first requester.

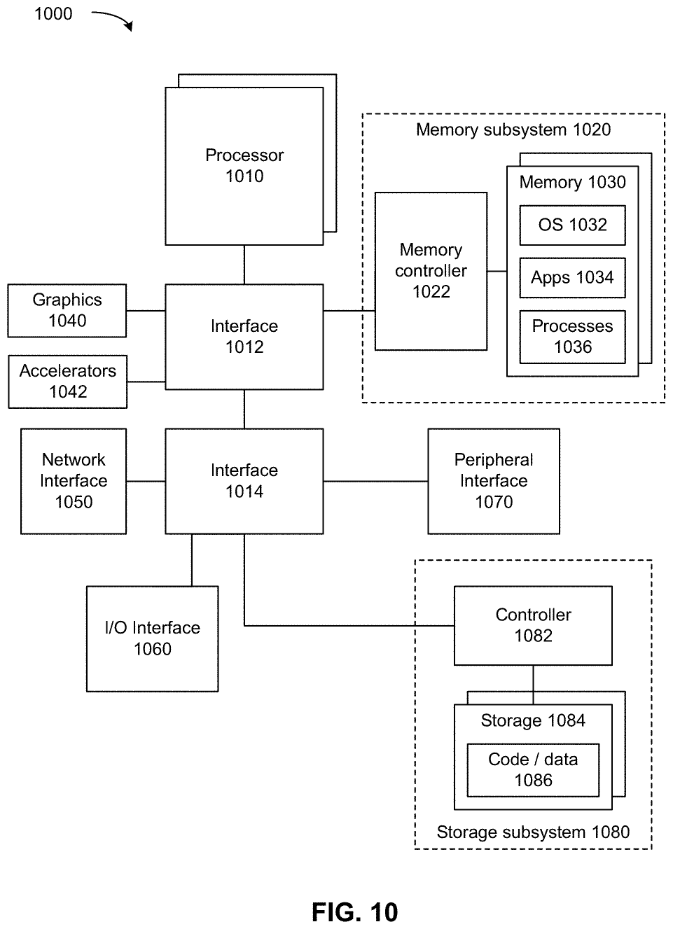

FIG. 10 depicts a system. The system can use embodiments described herein to reserve a region of a cache in accordance with embodiments described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080 p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function offload engine that can be accessed or used by a processor 1010. Accelerators 1042 can be coupled to processor 1010 using a memory interface (e.g., DDR4 and DDR5) or using any networking or connection standard described herein. For example, an accelerator among accelerators 1042 can provide sequential and speculative decoding operations in a manner described herein, compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. Various embodiments can be used in connection with network interface 1050, processor 1010, and memory subsystem 1020.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. Dynamic volatile memory can involve refreshing the data stored in the device to maintain state. One example of dynamic volatile memory incudes DRAM (Dynamic Random Access Memory), or some variant such as Synchronous DRAM (SDRAM). An example of a volatile memory includes a cache. A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects between components can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

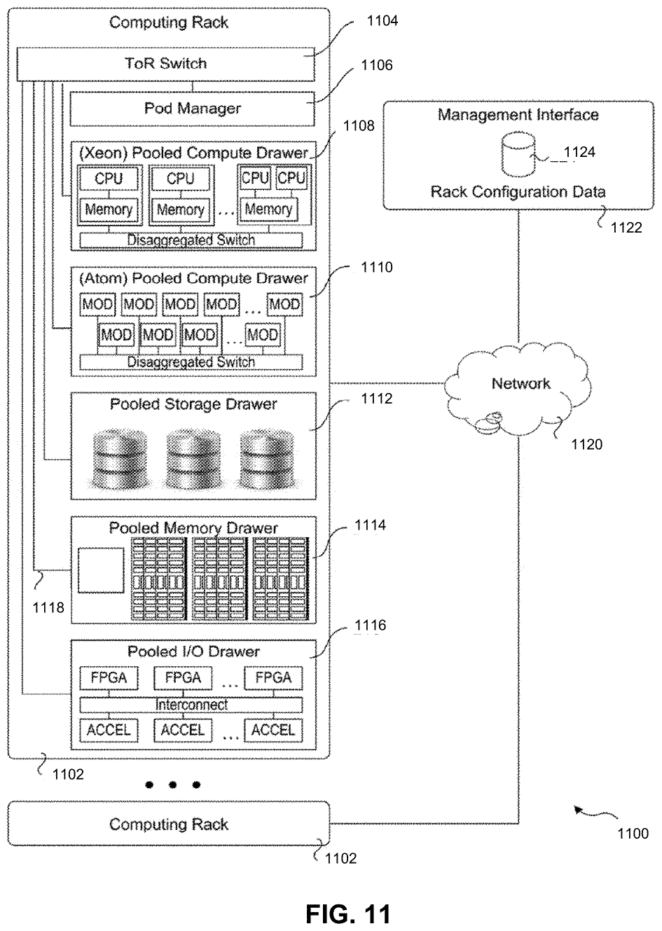

FIG. 11 depicts an environment 1100 includes multiple computing racks 1102, some including a Top of Rack (ToR) switch 1104, a pod manager 1106, and a plurality of pooled system drawers. Various embodiments can be used in or with the switch to perform link establishment, link training or link re-training in accordance with embodiments described herein. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 1108, and Intel® ATOM™ pooled compute drawer 1110, a pooled storage drawer 1112, a pooled memory drawer 1114, and a pooled I/O drawer 1116. Some of the pooled system drawers is connected to ToR switch 1104 via a high-speed link 1118, such as a 40 Gigabit/second (Gb/s) or 100 Gb/s Ethernet link or a 100+ Gb/s Silicon Photonics (SiPh) optical link. In one embodiment high-speed link 1118 comprises an 800 Gb/s SiPh optical link.

Multiple of the computing racks 1102 may be interconnected via their ToR switches 1104 (e.g., to a pod-level switch or data center switch), as illustrated by connections to a network 1120. In some embodiments, groups of computing racks 1102 are managed as separate pods via pod manager(s) 1106. In one embodiment, a single pod manager is used to manage racks in the pod. Alternatively, distributed pod managers may be used for pod management operations.

Environment 1100 further includes a management interface 1122 that is used to manage various aspects of the environment. This includes managing rack configuration, with corresponding parameters stored as rack configuration data 1124.

In some examples, embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus comprising: a cache and a controller to manage use of at least one region of the cache, the controller to: indicate availability of a cache region reservation feature; receive a request to reserve a region of the cache from a requester; and based on the requested region being permitted to be reserved by the requester, solely allow the requester to write data to at least a portion of the reserved region.

Example 2 includes any example, wherein the requester comprises one or more of: an application, orchestrator, hypervisor, virtual machine, or container.

Example 3 includes any example, wherein the controller is configurable to apply one of multiple retention policies to content stored in the reserved region and wherein the controller is to write to a register to indicate availability of a cache region reservation feature.

Example 4 includes any example, wherein the register comprises one or more of: a model specific register (MSR), memory-mapped I/O (MMIO), one or more memory type range registers (MTRRs), a memory region, or one or more register files.

Example 5 includes any example, wherein the request to reserve a region of the cache from a requester comprises a specification of a number of sets, a number of ways, and a class of service.

Example 6 includes any example, wherein the request to reserve a region of the cache from a requester is written in a register.

Example 7 includes any example, wherein the controller is to deny a request to reserve a region of the cache from a requester based at least on a portion of the region being locked or reserved by requester.

Example 8 includes any example, wherein the controller is to deny a request to reserve a region of the cache based at least on data associated with the requester not having a priority level to reserve the region.

Example 9 includes any example, wherein the cache comprises one or more of: a translation lookaside buffer (TLB), second level TLB, L2 TLB, L3 TLB, level-1, level-2, level-3, last level cache (LLC), or decoded instruction stream cache.

Example 10 includes any example, and includes one or more of a server, data center, rack, or network interface and wherein the controller is used in a server, data center, rack, or network interface.

Example 11 includes any example, and includes a computer-implemented method that includes: indicating availability of a cache region reservation feature; receiving a request to reserve a region of the cache from a requester; and based on the requested region being permitted to be reserved for the requester, allowing the requester to exclusively write data to the requested region.

Example 12 includes any example, and includes receiving a content retention policy for the reserved region from the requester.

Example 13 includes any example, wherein the content retention policy comprises a rate at which content stored in the reserved region is permitted to be evicted.

Example 14 includes any example, wherein the indicating availability of a cache region reservation feature comprises writing availability of a cache region reservation feature to a register.

Example 15 includes any example, wherein the register comprises one or more of: a model specific register (MSR), memory-mapped I/O (MMIO), one or more memory type range registers (MTRRs), a memory region, or one or more register files.

Example 16 includes any example, wherein the request to reserve a region of the cache comprises a specification of a number of sets, a number of ways, and a class of service.

Example 17 includes any example, and includes denying a request to reserve a region of the cache based at least on a portion of the region being reserved, the request does not specify a priority level that is high enough to reserve the region, or the region being locked or reserved for use by another application.

Example 18 includes any example, and includes a computer-readable medium, comprising instructions stored thereon, that if executed by one or more processors, cause the one or more processors to: execute an operating system, the operating system to: indicate availability of a cache region reservation feature to one or more requesters, wherein: the cache region reservation feature is to permit a requester to reserve a region of a cache to be written-to solely by a permitted requester and a requester is permitted to reserve a region of the cache based on a sufficient class of service specified in the request and availability of the region to be reserved.

Example 19 includes any example, and includes instructions stored thereon, that if executed by one or more processors, cause the one or more processors to: configure the operating system to indicate availability of setting a cache retention policy for a reservable region of the cache by one or more requesters.

Example 20 includes any example, wherein a cache management controller is to indicate a capability for a requester to utilize the cache region reservation feature.

Example 21 includes any example, and includes a system comprising: a server comprising: at least one processor; a cache; a memory; an interface to copy data from a received packet to the memory or the at least one cache; and a controller to manage use of at least one region of the cache, the controller to: indicate availability of a cache region reservation feature; receive a request to reserve a region of the cache from a requester; and based on the requested region being permitted to be reserved by the requester, solely allow the requester to write data to at least a portion of the reserved region.

Example 22 includes any example, wherein the controller is to write to a register to indicate availability of a cache region reservation feature.

Example 23 includes any example, wherein the request to reserve a region of the cache from a requester comprises a specification of a number of sets, a number of ways, and a class of service.

What is claimed is:

1. An apparatus comprising:
a cache and
a controller to manage use of at least one region of the cache, the controller to:
indicate availability of a cache region reservation feature;
receive a request to reserve a region of the cache from a requester; and
based on the requested region being permitted to be reserved by the requester, solely allow the requester to write data to at least a portion of the reserved region.

2. The apparatus of claim 1, wherein the requester comprises one or more of: an application, orchestrator, hypervisor, virtual machine, or container.

3. The apparatus of claim 1, wherein the controller is configurable to apply one of multiple retention policies to content stored in the reserved region and wherein the controller is to write to a register to indicate availability of a cache region reservation feature.

4. The apparatus of claim 3, wherein the register comprises one or more of: a model specific register (MSR), memory-mapped I/O (MMIO), one or more memory type range registers (MTRRs), a memory region, or one or more register files.

5. The apparatus of claim 1, wherein the request to reserve a region of the cache from a requester comprises a specification of a number of sets, a number of ways, and a class of service.

6. The apparatus of claim 1, wherein the request to reserve a region of the cache from a requester is written in a register.

7. The apparatus of claim 1, wherein the controller is to deny a request to reserve a region of the cache from a requester based at least on a portion of the region being locked or reserved by requester.

8. The apparatus of claim 1, wherein the controller is to deny a request to reserve a region of the cache based at least on data associated with the requester not having a priority level to reserve the region.

9. The apparatus of claim 1, wherein the cache comprises one or more of: a translation lookaside buffer (TLB), second level TLB, L2 TLB, L3 TLB, level-1, level-2, level-3, last level cache (LLC), or decoded instruction stream cache.

10. The apparatus of claim 1, comprising one or more of a server, data center, rack, or network interface and wherein the controller is used in a server, data center, rack, or network interface.

11. A computer-implemented method comprising:
indicating availability of a cache region reservation feature;
receiving a request to reserve a region of the cache from a requester; and
based on the requested region being permitted to be reserved for the requester, allowing the requester to exclusively write data to the requested region.

12. The method of claim 11, comprising:
receiving a content retention policy for the reserved region from the requester.

13. The method of claim 12, wherein the content retention policy comprises a rate at which content stored in the reserved region is permitted to be evicted.

14. The method of claim 11, wherein the indicating availability of a cache region reservation feature comprises writing availability of a cache region reservation feature to a register.

15. The method of claim 14, wherein the register comprises one or more of: a model specific register (MSR), memory-mapped I/O (MMIO), one or more memory type range registers (MTRRs), a memory region, or one or more register files.

16. The method of claim 11, wherein the request to reserve a region of the cache comprises a specification of a number of sets, a number of ways, and a class of service.

17. The method of claim 11, comprising:
denying a request to reserve a region of the cache based at least on a portion of the region being reserved, the request does not specify a priority level that is high enough to reserve the region, or the region being locked or reserved for use by another application.

18. A computer-readable medium, comprising instructions stored thereon, that if executed by one or more processors, cause the one or more processors to:
execute an operating system, the operating system to:
indicate availability of a cache region reservation feature to one or more requesters, wherein:
the cache region reservation feature is to permit a requester to reserve a region of a cache to be written-to solely by a permitted requester and
a requester is permitted to reserve a region of the cache based on a sufficient class of service specified in the request and availability of the region to be reserved.

19. The computer-readable medium of claim 18, comprising instructions stored thereon, that if executed by one or more processors, cause the one or more processors to:
configure the operating system to indicate availability of setting a cache retention policy for a reservable region of the cache by one or more requesters.

20. The computer-readable medium of claim 18, wherein a cache management controller is to indicate a capability for a requester to utilize the cache region reservation feature.

21. A system comprising:
a server comprising:
at least one processor;
a cache;
a memory;
an interface to copy data from a received packet to the memory or the at least one cache; and
a controller to manage use of at least one region of the cache, the controller to:
indicate availability of a cache region reservation feature;
receive a request to reserve a region of the cache from a requester; and
based on the requested region being permitted to be reserved by the requester, solely allow the requester to write data to at least a portion of the reserved region.

22. The system of claim 21, wherein the controller is to write to a register to indicate availability of a cache region reservation feature.

23. The system of claim 21, wherein the request to reserve a region of the cache from a requester comprises a specification of a number of sets, a number of ways, and a class of service.
